(19) United States
(12) Patent Application Publication
(10) Pub. No.: US 2026/0254773 A1
(43) Pub. Date: Aug. 27, 2026

(54) SUPPORT FOR HIGH-AVAILABILITY ETHERNET PROTOCOLS IN OVERLAY NETWORKS

(71) Applicant: HEWLETT PACKARD ENTERPRISE DEVELOPMENT LP, Spring, TX (US)

(72) Inventors: Tathagata Nandy, Bangalore (IN); Venkatavaradhan Devarajan, Bangalore (IN); Pramod Kumar A. S., Bangalore (IN); Pranay Nawghare, Bangalore (IN); Vincent Giles, Grenoble (FR); Mark Gooch, Roseville, CA (US)

(21) Appl. No.: 19/187,418

(22) Filed: Apr. 23, 2025

(30) Foreign Application Priority Data
Feb. 27, 2025 (EP) 25305262.5

(51) Int. Cl. H04L 49/113; H04L 12/46; H04L 45/243; H04L 47/125

(52) U.S. Cl. CPC H04L 49/113; H04L 12/4645; H04L 45/243; H04L 47/125

(57) ABSTRACT

One aspect of the instant disclosure provides a system and method for implementing Parallel Redundancy Protocol (PRP) in a network. During operation, a network device operating as a source tunnel endpoint may determine whether a received packet is a Parallel Redundancy Protocol (PRP) packet. In response to determining that the received packet is not a PRP packet, the network device may apply Equal-Cost Multi-Path (ECMP)-based load balancing and forwarding the received packet to an ECMP next-hop network device toward a destination tunnel endpoint. In response to determining that the received packet is a PRP packet, forwarding the received packet to a predetermined next-hop network device toward the destination tunnel endpoint.

### BACKGROUND

Industry 4.0 and smart manufacturing initiatives have driven the adoption of cutting-edge digital technologies in industrial settings, including the Internet of Things (IoT), Artificial Intelligence (AI), and big data analytics. This technological integration has fueled the rapid growth of the industrial Ethernet market. Industrial networks, unlike consumer networks, demand more stringent latency and fault tolerance requirements.

While Ethernet is not inherently fault-tolerant, it can be enhanced with smart, situation-aware redundancy protocols to provide seamless failover against network component failures. Parallel Redundancy Protocol (PRP) and High-availability Seamless Redundancy (HSR) have been implemented to achieve zero-loss redundancy in wired Ethernet networks. However, industrial networks increasingly rely on overlay technologies to provide mobility, security, usability, and flexibility, which presents a significant challenge for implementing redundancy protocols like PRP.

### BRIEF DESCRIPTION OF THE FIGURES

FIG. 1 illustrates an example EVPN-VxLAN network that supports Parallel Redundancy Protocol (PRP), according to one aspect of the instant disclosure.

FIG. 2 illustrates an example encapsulated PRP packet, according to one aspect of the instant disclosure.

FIG. 3 illustrates an example packet-forwarding process, according to one aspect of the instant disclosure.

FIG. 4 illustrates an example functional block diagram of a network device for implementing PRP in an overlay network, according to one aspect of the instant disclosure.

FIG. 5 illustrates a computer-readable medium (CRM) that facilitates implementing PRP in an overlay network, according to one aspect of the instant disclosure.

In the figures, like reference numerals refer to the same figure elements.

### DETAILED DESCRIPTION

Parallel Redundancy Protocol (PRP) is a network redundancy protocol designed for industrial Ethernet networks that require high availability and zero recovery time. PRP is particularly valuable in critical infrastructure and industrial control systems where even brief downtimes can lead to significant losses, such as the control system of a power grid or manufacturing robot arms. It provides a robust solution for industries such as power utilities and manufacturing, where continuous operation is crucial.

PRP achieves redundancy by using two independent, parallel Local Area Networks (LANs). Devices with PRP capability, known as Doubly Attached Nodes obeying PRP (DANPs), simultaneously send identical packets over both LANs. Each packet is appended with a Redundancy Control Trailer (RCT) containing a sequence number, LAN identifier, and other information to manage duplicates. The destination node accepts the first packet that arrives and discards the duplicate. The two LANs are assumed to have separate fault domains, thus ensuring that the destination node will always receive at least one packet, as long as either one of the two networks is up or operational. The redundant network provides zero-time recovery in case of a single failure, so no packet is lost. PRP operates transparently to upper-layer protocols and applications, making it suitable for various network topologies and Ethernet networks.

Modern campus networks are typically built using EVPN-VxLAN-based overlay technology that combines the strengths of EVPN and VXLAN to create a scalable and flexible network solution. More specifically, EVPN-VXLAN uses VXLAN to encapsulate Layer 2 Ethernet frames within Layer 3 IP packets, allowing for the creation of a large number of virtual network segments, with each segment being uniquely identified by a 24-bit VXLAN Network Identifier (VNI). EVPN serves as the control plane for this network architecture, leveraging Border Gateway Protocol (BGP) to distribute Media Access Control (MAC) and Internet Protocol (IP) address information efficiently across the network. Virtual Tunnel Endpoints (VTEPs) at the network edges handle the encapsulation and decapsulation of packets, establishing BGP sessions to exchange address information dynamically. To improve the network performance, reliability, and scalability, a typical EVPN-VxLAN-based network implements Equal-Cost Multi-Path (ECMP) routing, which allows for the distribution of traffic across multiple paths of equal cost to the same destination. However, the implementation of ECMP routing may be troublesome for PRP, as ECMP cannot guarantee the isolation or independence of the two paths. EVPN-VxLAN-based networks may require special software and hardware support to enable PRP.

According to some aspects of the instant disclosure, nodes in an EVPN-VxLAN network may be configured to distinguish between PRP and non-PRP traffic and treat them differently. More specifically, PRP traffic may be forwarded from a source node to a destination node along a designated path to the destination, whereas non-PRP traffic may be load-balanced using standard equal-cost multi-path routing (ECMP) at each node for the non-PRP traffic.

As used herein, the term “node” may refer to one or more computing devices configured to emulate one or more, or all, of the functions described herein. As used herein, a “computing device” may be a server, a cluster of servers, a storage array, a computer appliance, a workstation, a desktop computer, a laptop computer, a switch, a router, or any other processing device or equipment including a processing resource. In an example, the node may include a processing resource communicatively coupled to at least one non-transitory computer-readable storage medium including instructions that, when executed by the processing resource, cause the node to undertake certain actions and functionalities as described herein.

The term “switch” is used in a generic sense, and it can refer to any standalone or fabric switch operating in any network layer. “Switch” should not be interpreted as limiting aspects of the present invention to layer-2 networks. Any device that can forward traffic to an external device or another switch can be referred to as a “switch.” Any physical or virtual device (e.g., a virtual machine or switch operating on a computing device) that can forward traffic to an end device can be referred to as a “switch.” Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting aspects of the present invention to layer-3 networks. “Packet” can be replaced by other terminologies referring to a group of bits, such as “message,” “frame,” “cell,” “datagram,” or “transaction.” Furthermore, the term “port” can refer to the port that can receive or transmit data. “Port” can also refer to the hardware, software, and/or firmware logic that can facilitate the operations of that port.

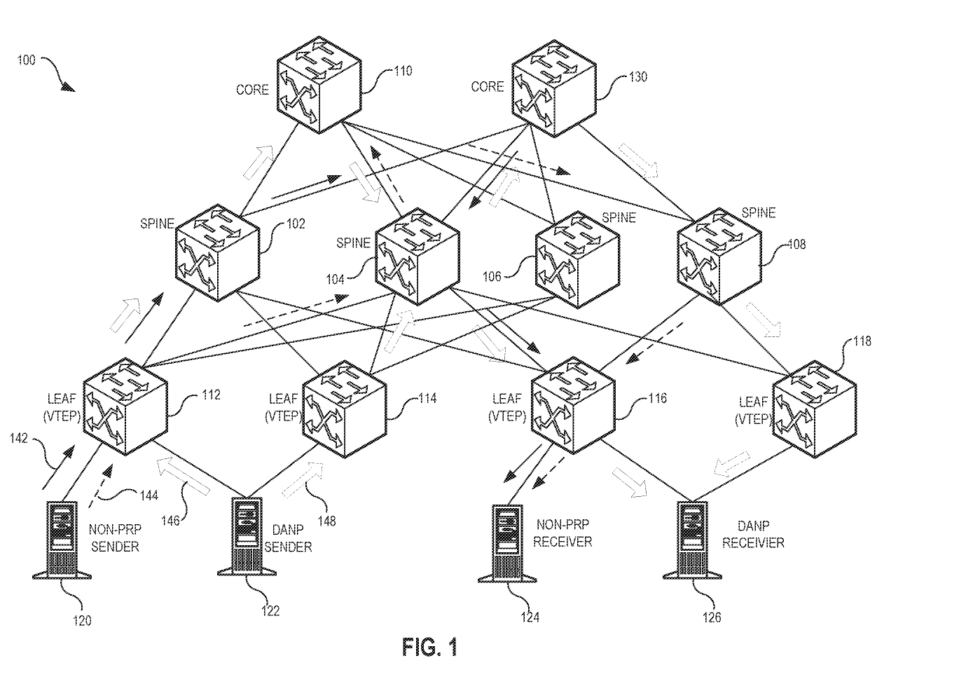

FIG. 1 illustrates an example EVPN-VxLAN network that supports Parallel Redundancy Protocol (PRP), according to one aspect of the instant disclosure. In FIG. 1, EVPN-VxLAN network 100 has a spine-and-leaf topology, in which the spine switches (e.g., switches 102, 104, 106, and 108) and the super spine or core switches (e.g., switches 110 and 130) form the backbones of the network, and the leaf switches (e.g., switches 112, 114, 116, and 118) are connected to end devices (e.g., servers 120, 122, 122, and 126). Each super spine switch may be connected with all spine switches, and each spine switch may be connected with all the leaf switches in a mesh topology. In addition to the mesh topology, other topologies are also possible.

The leaf switches operate as VxLAN tunnel endpoints (VTEPs) that are VxLAN capable and are responsible for encapsulating and decapsulating packets. The spine and super spine switches may form the underlying network for delivering traffic from a source VTEP to a destination VTEP. In conventional implementations, switches in EVPN-VxLAN network 100 may apply Equal-Cost Multi-Path (ECMP) routing on all traffic to balance the load. For example, traffic may be routed on the multiple ECMP paths established between the source and destination VTEPs. ECMP-based load balancing may be performed on a per-flow basis, where packets belonging to the same flow may select one path, and different flows may be sent (e.g., via ECMP hashing) on different paths traversing multiple spines. This presents a challenge for implementing PRP in EVPN-VxLAN network 100, because PRP requires two completely isolated paths between the sender and receiver nodes such that the failure of one link or device on one path does not affect the other path. To implement PRP, according to some aspects of the instant disclosure, each switch in EVPN-VxLAN network 100 may be configured to override ECMP for PRP traffic while allowing ECMP to be used for non-PRP traffic.

In the example shown in FIG. 1, EVPN-VxLAN network 100 includes end devices (e.g., servers) that send or receive PRP packets and end devices that send or receive regular or non-PRP packets. PRP packets may originate from mission-critical applications (e.g., protecting substations in an electrical grid)that demand high availability. An end device that sends or receives PRP packets is a DANP node, which includes two Ethernet ports connected to two VTEPs. On the other hand, end devices that send or receive non-PRP packets may be referred to as non-PRP nodes. In FIG. 1, server 122 is a DANP sender node and is connected to VTEPs (or leaf switches) 112 and 114, and server 126 is a DANP receiver node and is connected to VTEPs (or leaf switches) 116 and 118. Server 120 is a non-PRP sender connected to VTEP 112, and server 124 is a non-PRP receiver connected to VTEP 116.

According to some aspects, non-PRP packets may traverse the underlay network using multiple ECMP paths at different nodes before reaching the receiver node. FIG. 1 shows two example ECMP paths between non-PRP sender node 120 and non-PRP receiver node 124, as indicated with solid and dashed arrows, such as solid arrow 142 and dashed arrow 144. In one example, non-PRP sender node 120 may send a non-PRP packet to VTEP 112, which applies ECMP and forwards the packet to next-hop spine switch 102. Similarly, spine switch 102 applies ECMP to forward the packet to core switch 130, and the packet subsequently passes spine switch 104 and VTEP 116 before it arrives at non-PRP receiver 124. This path traversed by the packet is indicated using solid arrows. In another example, responsive to receiving a non-PRP packet from sender node 120, the ECMP algorithm executed on VTEP 112 may select spine switch 104 as the next-hop device, followed by core switch 110, spine switch 108, and VTEP 116, before the packet arrives at non-PRP receiver 124. This path is indicated using dashed arrows. To prevent out-of-order packets, the ECMP hashing operation may be configured to ensure that packets belonging to the same flow may follow the same path.

Unlike ECMP routing where traffic between source and destination VTEPs may be load-balanced over multiple best paths with equal metrics, PRP traffic requires traffic between source and destination VTEPs to travel on a predetermined fixed path. To achieve such a goal, at each source VTEP, PRP traffic needs to be steered to a specific device by overriding or disabling ECMP. In the example shown in FIG. 1, DANP sender node 122 may send a PRP packet and its duplicate to VTEPs 112 and 114, respectively. Upon receiving the PRP packet, VTEP 112 may override ECMP and forward the PRP packet to a designated next-hop spine switch 102, which in turn may recognize the packet as a PRP packet and override ECMP when forwarding the packet. Other switches in the underlay network may behave similarly to ensure that the PRP packet follows one predetermined path (marked by solid hollow arrows, such as a solid hollow arrow 146) until it arrives at DANP receiver node 126. On the other hand, the duplicate packet is sent to a different VTEP 114, which may similarly recognize the duplicate packet as a PRP packet (or requiring PRP protection) and override ECMP to forward the duplicate packet to a different designated next-hop spine switch 104. The path taken by the duplicate packet is indicated using dashed hollow arrows in FIG. 1 (such as a dashed hollow arrow 148) and may include core switch 130, spine switch 108, and VTEP 118. As illustrated in FIG. 1, the paths taken by these two identical PRP packets are isolated (i.e., they do not overlap). This provides the desired path redundancy.

In the example shown in FIG. 1, the VTEPs and intermediate switches (e.g., the core and spine switches) should be able to distinguish PRP packets from non-PRP packets to treat them differently. According to some aspects, each VTEP may reserve a particular physical port for PRP, and this PRP-specific port is connected to the DANP to receive PRP packets. This arrangement allows the VTEP to distinguish PRP packets from non-PRP packets based on the incoming port. Packets received from the PRP-specific physical port are recognized as PRP packets, whereas other packets are recognized as non-PRP packets. According to some aspects, PRP packets should always be forwarded to a designated spine, whereas non-PRP packets may be forwarded to different spines, depending on the outcome of ECMP-based load balancing. In one example, packets arrived on the PRP-specific port may be mapped to a specific VLAN reserved for PRP (referred to as a PRP-VLAN). In a further example, ASIC metadata associated with the PRP-VLAN may be set to override the ECMP. In addition to a physical port, packets may also be recognized as PRP packets based on the persona type on the interface or the role assignment of the interface.

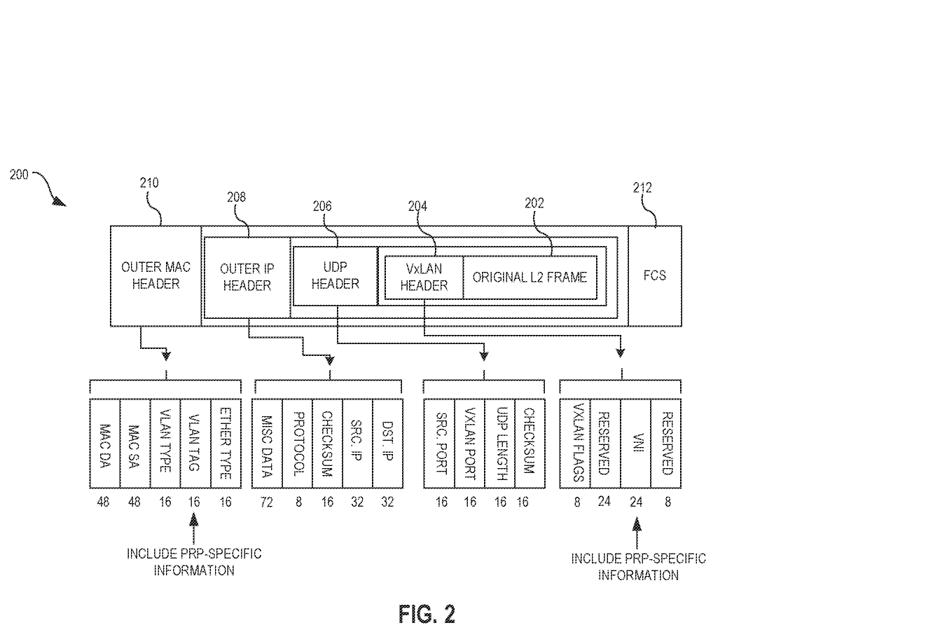

According to some aspects, at the egress of the source VTEP, a PRP packet is encapsulated with a VxLAN header and recirculated back to the ingress of the source VTEP. The VxLAN header may include information useful for steering the packet to a predetermined next-hop port after overriding ECMP. FIG. 2 illustrates an example encapsulated PRP packet, according to one aspect of the instant disclosure. In FIG. 2, a VxLAN PRP packet 200 may include an original layer-2 (L2) frame 202 encapsulated with a VxLAN header 204, a UDP header 206, an outer IP header 208, an outer MAC header 210, and a frame check sequence (FCS) field 222.

FIG. 2 shows that VxLAN header 204 includes two reserved fields (which may all be set to zero), an eight-bit VxLAN flag field (which may have a value of 00001000), and a 24-bit VNI field. The VNI field contains a VxLAN network identifier used to identify a VxLAN segment. A VxLAN tunnel may be created between the source and destination VTEPs. According to some aspects, a PRP-specific VNI may be assigned to the PRP packet. After recirculating back to the ingress, the packet may be processed by the packet-processing engine again, which may apply policy-based routing (PBR) based on a match done on the VNI. For example, the policy may redirect all matched packets (e.g., the PRP packets) to a specified next-hop port on the source VTEP connected to a separate device (such as a spine switch). Non-PRP packets, on the contrary, will not be recirculated, they may simply be encapsulated with the default VxLAN header and are hashed (e.g., select the next-hop port from the ECMP port list) based on the VxLAN hash. Non-PRP traffic may apply ECMP to load balance across multiple spines.

According to alternative aspects, there is no need to recirculate PRP packets after encapsulation. To override ECMP and to steer PRP packets to a specified/desired underlay port, the switch ASIC (e.g., the packet-processing pipeline or engine) may be configured to perform a match on the packet based on its incoming port and VLAN (e.g., whether it is a particular VLAN for a critical application). The metadata in the ASIC header of the packet may be set to override the ECMP decision during egress, forcing a matching packet to egress on a designated next-hop port.

In FIG. 2, outer IP header field 208 includes the source and destination IP addresses, which correspond to the IP addresses of the source and destination VTEPs, respectively. Intermediate nodes (e.g., spine and core switches) in the network may forward packets based on information included in outer IP header field 208 and ignore any information included in the inner headers (e.g., headers in the original Ethernet packet) as the inner headers are now part of the payload of the encapsulated packets. Moreover, outer MAC header field 210 includes a VLAN tag field that specifies a VLAN to which the packet belongs. More specifically, if the packet is a PRP packet (i.e., it comes from a PRP-VLAN in the overlay network), a PRP-specific VLAN tag may be inserted in outer MAC header field 210. This VLAN tag may serve as an indicator to indicate that the packet is a PRP packet.

Setting the VLAN tag in outer MAC header field 210 may be done in the data plane based on the VLAN associated with an incoming packet. In some examples, the packet-processing logic in the source VTEP can associate an internal reserved VLAN with PRP packets (e.g., packets coming from PRP applications). At egress, a match on this VLAN can be used to insert a VLAN tag in outer MAC header field 210. This VLAN tag may allow the packet to be steered seamlessly in the underlay network (i.e., the underlying IP network).

Each VLAN may be mapped to a specific VRF (Virtual Routing and Forwarding) network in the underlay network. According to some aspects, PRP and non-PRP VLANs will be mapped to different VRFs. More specifically, each PRP-VLAN may be mapped to one separate VRF. In one example, a VRF for a PRP-VLAN may be referred to as transport_vrf.

According to some aspects, the underlay routing protocols implemented in the spine and core switches may be set up with proper cost such that packets coming from a PRP-specific VRF/VLAN may be forwarded on a specific path, overriding ECMP at the underlay spines. In some examples, each PRP-VLAN may be provided with a designated path by adjusting the Open Shortest Path First (OSPF) cost on the transport_vrf in the underlay. More specifically, the OSPF cost on each intermediate node (e.g., a spine or core switch) may be configured such that PRP traffic will take a unique path from the source VTEP to the destination VTEP. Alternatively, other IP-routing underlay protocols (e.g., external Border Gateway Protocol (eBGP)) may be used to achieve the same goal. In one example, eBGP-based underlay may be created by enabling eBGP as the routing protocol on the intermediate nodes to provide each PRP-VLAN with a designated path. An interior gateway protocol (IGP) such as Intermediate System to Intermediate System (ISIS) may also be used. In some examples, the path taken by a PRP packet and the path taken by its duplicate are completely isolated completely (i.e., they do not overlap) such that a device failure in one path does not affect the other path.

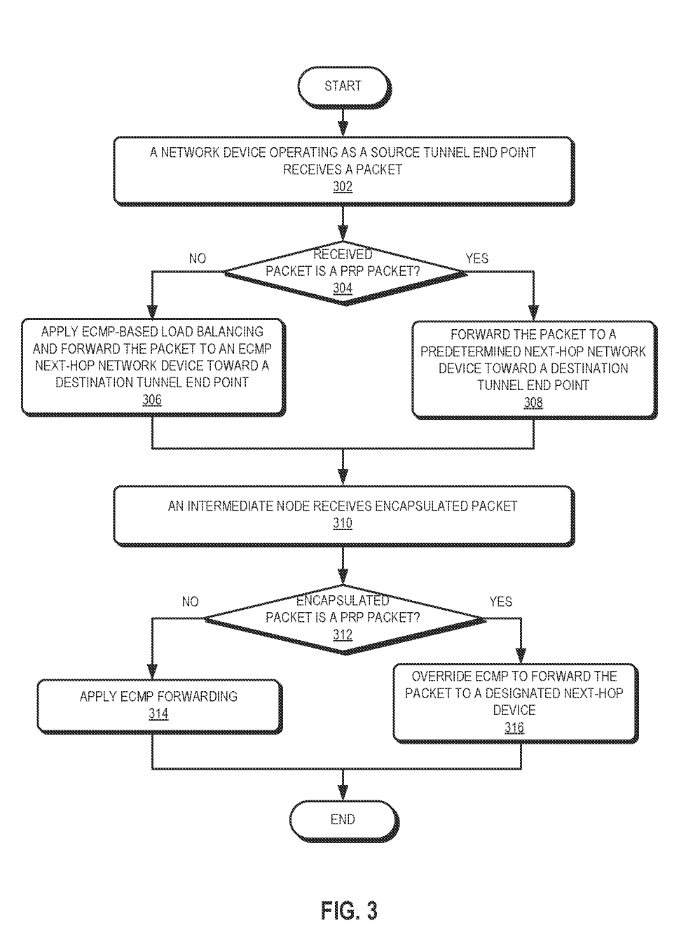

FIG. 3 illustrates an example packet-forwarding process, according to one aspect of the instant disclosure. During operation, a network device operating as a source tunnel endpoint receives a packet (operation 302). The network device may be referred to as a source VTEP and may receive the packet from a sender device, which may be a regular server (e.g., a non-PRP sender) coupled to a single source VTEP or a DANP server coupled to two source VTEPs. The network device or source VTEP may determine whether the received packet is a PRP packet (operation 304). According to some aspects, the source VTEP may have a special physical port reserved for PRP, and the DANP server is coupled to the source VTEP via the reserved physical port. Accordingly, the source VTEP may determine whether the received packet is a PRP packet based on its incoming port. According to further aspects, the DANP server may be coupled to a second source VTEP to send a duplicate packet to the second source VTEP.

In response to determining that the received packet is not a PRP packet, the network device may apply ECMP-based load balancing and forward the received packet to an Equal-Cost Multi-Path (ECMP) next-hop network device toward a destination tunnel endpoint (operation 306). A packet received from a physical port that is not PRP-specific is not a PRP packet. By default, the network device may perform ECMP forwarding to load balance among a plurality of spine or core switches, which may involve performing ECMP hashing to determine the next-hop node (e.g., a spine switch) for forwarding the packet.

In response to determining that the received packet is a PRP packet, the network device may forward the received packet to a predetermined next-hop network device toward a destination tunnel endpoint (operation 308). A packet received from the PRP-specific physical port is a PRP packet. The VTEP has been configured such that the ASIC metadata is set to override ECMP based on the ingress port. In other words, the packet-forwarding logic in the source VTEP would override the ECMP forwarding decision on the PRP packet and forward the PRP packet to a designated next-hop device. The packet-forwarding logic in a switch (e.g., a VTEP) may include various hardware and/or software logic blocks used to determine how data packets are directed from their source to destination, including but not limited to logics for extracting packet headers, logics for looking up the forwarding table, logics for making a forward decision, logics for updating the forwarding table, logics for implementing Quality of Service (QoS), etc. Note that the default behavior of the packet-forwarding logic in a switch (e.g., a VTEP) is to apply ECMP when making a forwarding decision. According to some aspects, overriding the ECMP ensures that packets of the same sequence should not be forwarded to different links of the same switch. In the example shown in FIG. 1, the designated next-hop device for source VTEP 112 is spine switch 102, whereas the designated next-hop device for source VTEP 114 is spine switch 104. This arrangement ensures that the PRP packet and its duplicate are sent to different spines to provide isolation between the two parallel paths.

According to some aspects, a special VLAN (referred to as PRP-VLAN) may be reserved for the PRP traffic, with the access port for the PRP-VLAN being the physical port connected to a DANP node. In some examples, after bypassing ECMP forwarding, packets mapped to the PRP-VLAN may be encapsulated with a VxLAN header, which includes a PRP-specific VNI. The encapsulated packet may be recirculated back to the ingress of the source VTEP, where a match may be done based on the PRP-specific VNI. A PBR policy may be applied to a matched packet, causing the packet to be forwarded to the designated next-hop device. In alternative examples, the encapsulated packet will not be recirculated. Instead, PRP packets may be identified based on their incoming port, and the metadata in the ASIC header of the PRP packets may be set to override ECMP during egress, forcing the PRP packets to be forwarded to the designated next-hop device.

Moreover, the network administrator may create different VRFs for PRP traffic and non-PRP traffic. For example, each switch in the network may be configured with multiple VRFs, including a PRP-specific VRF. The source VTEP may insert a VLAN tag into the outer MAC header field of an encapsulated PRP packet, specifying the PRP-remapped VLAN on the PRP-specific VRF. To do so, for a given PRP-VLAN, the packet-forwarding logic in the source VTEP may try to resolve the underlay for the destination VTEP associated with the PRP-VLAN. If resolved, the next-hop VLAN would be the PRP-remapped VLAN on the PRP-specific VRF, and its identifier will be inserted into the outer MAC header field of the encapsulated packet. This mechanism ensures the dynamic learning of the designated next-hop device.

An intermediate node (e.g., a spine or core switch) receives the encapsulated packet (operation 310) and determines whether the packet is a PRP packet (operation 312). According to some aspects, the intermediate node may determine whether a received packet is a PRP packet based on a PRP-specific indicator in the encapsulation header (e.g., the VLAN tag in the outer MAC field). If the VLAN tag corresponds to a VLAN mapped to a VRF for non-PRP traffic, the packet is not a PRP packet. Accordingly, the intermediate node may apply ECMP forwarding on the packet to load balance among multiple core switches (operation 314). Due to ECMP-based load balancing, the path taken by the non-PRP packet is not deterministic.

If the VLAN tag corresponds to a VLAN mapped to a PRP-specific VRF, the intermediate node may override ECMP to forward the packet to a designated next-hop device (operation 316). The designated next-hop device is the next-hop node in the PRP-remapped VLAN. According to some aspects, each intermediate node may override ECMP forwarding for PRP packets, and packets belonging to the same PRP-VLAN flow may be forwarded to a designated next-hop node. This way, a specific path corresponding to the PRP-VLAN flow may be stitched from switch to switch until it reaches the destination VTEP. According to further aspects, to ensure the correct forwarding of the packets in the PRP-VLAN, the OSPF cost for each link may be adjusted on the PRP-specific VRF. According to alternative aspects, an intermediate node may compute ECMP paths for the PRP packets. However, instead of using ECMP hash to select a port from a port list to forward packets, the intermediate node may be configured to select a predetermined port (e.g., the first or last one) from the port list to forward packets.

Each intermediate node in the network fabric behaves similarly by steering PRP traffic to a designated next-hop node without applying ECMP and by using ECMP to load balance non-PRP traffic across the multiple spine/core switches. Paths taken by the PRP traffic or the non-ECMP paths may also include redundant paths. For each transport VRF, multiple paths may coexist like a primary, a secondary, and a third path, with OSPF cost driving the path selection, as long as each transport VRF path does not overlap on a single node, which is the high-availability requirement for PRP. Upon arriving at the destination VTEP, the encapsulated PRP packets may be decapsulated on the PRP-specific VRF and sent to the overlay VLAN for forwarding to the receiver. Because a PRP packet and its duplicate traverse the network fabric over different, segregated VRFs, paths taken by these two packets are independent of each other.

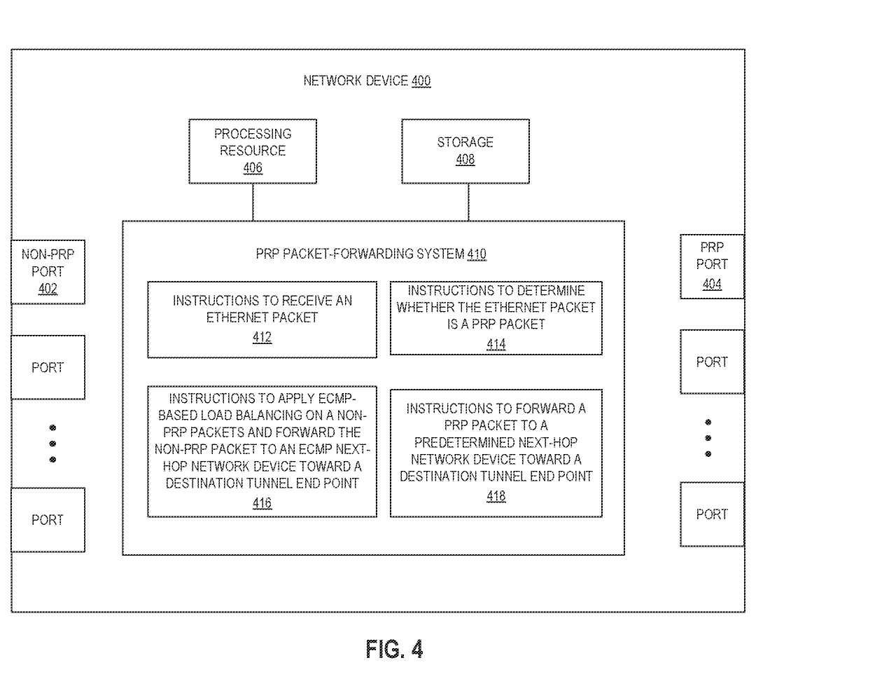

FIG. 4 illustrates an example functional block diagram of a network device for implementing PRP in an overlay network, according to one aspect of the instant disclosure. Network device 400 may include any physical devices that allow hardware on a computer network to communicate and interact with one another. Examples of network device 400 may include a switch, a router, a gateway, an access point, a network interface card (NIC), etc. According to some aspects, network device 400 may function as a source tunnel endpoint. Network device 400 may include a number of communication ports, such as ports 402 and 404, for communicating with peer network devices. In this example, port 402 is a non-PRP port for receiving non-PRP traffic, whereas port 404 is a PRP-specific port reserved for receiving PRP traffic. More specifically, port 402 may be connected to a non-PRP sender device, whereas port 404 may be connected to a DANP sender device (e.g., a server running PRP applications).

Network device 400 may include one or more processing resources (e.g., processing resource 406), one or more storage devices (e.g., storage device 408), and a PRP packet-forwarding system 410.

A processing resource may include, for example, one processor or multiple processors included in a single computing device or distributed across multiple computing devices. In some examples, the concurrent processes may be executed on a single computing device or multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution. In the examples illustrated herein, the node may be implemented by one computer-readable storage medium or multiple computer-readable storage media.

PRP packet-forwarding system 410 may include any number of software units, hardware units, and firmware units that work together to achieve the goal of forwarding PRP packets. According to some aspects, PRP packet-forwarding system 410 may include instructions, which when executed by processing resource 406 may cause processing resource 406 to perform methods and/or processes described in this disclosure. Specifically, PRP packet-forwarding system 410 may include instructions 412 to receive an Ethernet packet.

PRP packet-forwarding system 410 may include instructions 414 to determine whether the received Ethernet packet is a PRP packet. According to some aspects, instructions 414 may determine the incoming port of the Ethernet packet. If the incoming port of the packet is reserved for PRP (e.g., PRP-specific port 404), the packet is a PRP packet.

PRP packet-forwarding system 410 may include instructions 416 to apply ECMP-based load balancing on a non-PRP packet and forward the non-PRP packet to an Equal-Cost Multi-Path (ECMP) next-hop network device toward a target tunnel endpoint. Note that the default packet-forwarding operation of network device 400 is to apply ECMP to load balance among the multiple switches/routers in the network. If a packet is determined to be a regular packet, it will be forwarded according to the default operation.

PRP packet-forwarding system 410 may include instructions 418 to forward a PRP packet to a predetermined next-hop network device toward a destination tunnel endpoint. According to some aspects, instructions 418 may include instructions to override ECMP for PRP packets.

PRP packet-forwarding system 410 may include more instructions than those shown in FIG. 4. For example, PRP packet-forwarding system 410 may include instructions to insert a VLAN tag into the outer MAC header of a PRP packet, specifying that the encapsulated packet belongs to a PRP-specific VLAN, thus facilitating subsequent spine/core switches to recognize the packet being a PRP packet and to forward the packet on a designated path.

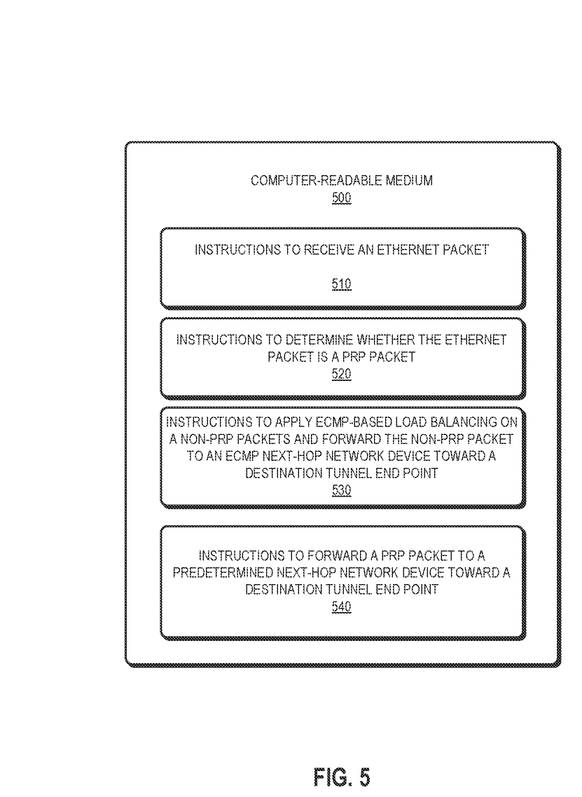

FIG. 5 illustrates a computer-readable medium (CRM) that facilitates implementing PRP in an overlay network, according to one aspect of the instant disclosure. CRM 500 may be a non-transitory computer-readable medium or device storing instructions that when executed by a computer or processing resource cause the computer or processing resource to perform a method. As used herein, a “computer-readable storage medium” may be any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

CRM 500 may store instructions 510 to receive an Ethernet packet; instructions 520 to determine whether the received Ethernet packet is a PRP packet; instructions 530 to apply ECMP-based load balancing on a non-PRP packet and forward the non-PRP packet to an Equal-Cost Multi-Path (ECMP) next-hop network device toward a target tunnel endpoint; and instructions 540 to forward a PRP packet to a predetermined next-hop network device toward a destination tunnel endpoint.

CRM 500 may include more instructions than those shown in FIG. 5. For example, CRM 500 may include instructions to insert a VLAN tag into the outer MAC header of a PRP packet, specifying that the encapsulated packet belongs to a PRP-specific VLAN, thus facilitating subsequent spine/core switches to recognize the packet being a PRP packet and to forward the packet on a designated path.

In general, aspects of the disclosure provide a system and method for supporting PRP in an overlay network (e.g., an EVPN-VxLAN network). Switches and routers in the network fabric may be configured to recognize PRP packets and to forward the PRP packets along a designated path from a source VTEP to a destination VTEP by overriding ECMP. On the other hand, ECMP load balancing may be applied to non-PRP packets as normal. The source VTEP may be connected to a DANP node via a PRP-specific physical port and may identify incoming packets from that PRP-specific port as PRP packets. At egress, the source VTEP may insert a VLAN tag into the outer MAC header of a PRP packet to indicate that the packet belongs to a PRP-specific VLAN, thus allowing intermediate nodes in the network fabric to recognize the packet as a PRP packet and forward the packet to a designated next-hop node, without applying ECMP.

In the examples shown in FIG. 1, the network connecting the VTEPs implements a mesh topology. In addition to the mesh topology, the instant solution may support other types of Metropolitan Area Network (MAN) or Wide Area Network (WAN) networks in between the VTEPs, as long as there are different physical paths assigned per underlay tenant (or VRF mapped to each PRP VLAN).

One aspect of the instant disclosure provides a system and method for implementing Parallel Redundancy Protocol (PRP) in an overlay network. During operation, a network device operating as a source tunnel endpoint may determine whether a received packet is a Parallel Redundancy Protocol (PRP) packet. In response to determining that the received packet is not a PRP packet, the network device may apply Equal-Cost Multi-Path (ECMP)-based load balancing and forwarding the received packet to an ECMP next-hop network device toward a destination tunnel endpoint. In response to determining that the received packet is a PRP packet, forwarding the received packet to a predetermined next-hop network device toward the destination tunnel endpoint.

In a variation on this aspect, a predetermined physical port on the network device is coupled to a PRP sender, and determining whether the received packet is a PRP packet may include identifying an incoming physical port of the received packet.

In a further variation, the PRP sender is coupled to a second network device operating as a second source tunnel endpoint, and the second network device is to receive a duplicate PRP packet and forward the duplicate PRP packet to a predetermined second next-hop network device toward a second destination tunnel endpoint, the second next-hop network device being different from the predetermined next-hop network device.

In a further variation, the PRP packet and the duplicate PRP packet are routed on independent, non-overlapping paths to a PRP receiver coupled to the first and second destination tunnel endpoints.

In a variation on this aspect, the network device may further encapsulate the received packet and, in response to determining that the received packet is a PRP packet, insert a PRP-specific indicator into a header field of the encapsulated packet.

In a further variation, the PRP-specific indicator may include a virtual local area network (VLAN) tag.

In a further variation, in response to detecting the PRP-specific indicator, an intermediate network device between the source and destination tunnel endpoints may forward the encapsulated packet to a designated next-hop network device toward the destination tunnel endpoint, thereby allowing the encapsulated packet to be routed on a PRP-specific path. In response to detecting an absence of the PRP-specific indicator, the intermediate network device may forward the encapsulated packet on an ECMP path toward the destination tunnel endpoint.

In a further variation, forwarding the encapsulated packet to the designated next-hop network device may include applying an IP-routing underlay protocol. The IP-routing underlay protocol may include open shortest path first (OSPF) or external Border Gateway Protocol (eBGP).

In a variation on this aspect, forwarding the received packet to a predetermined next-hop network device may include overriding ECMP forwarding and applying a Policy Based Routing (PRB) policy.

One aspect of the instant disclosure provides a network device operating as a source tunnel endpoint. The network device may include a processing resource and a non-transitory machine-readable storage medium comprising instructions executable by the processing resource to: determine whether a received packet is a Parallel Redundancy Protocol (PRP) packet; in response to determining that the received packet is not a PRP packet, apply Equal-Cost Multi-Path (ECMP)-based load balancing and forward the received packet to an ECMP next-hop network device toward a destination tunnel endpoint; and, in response to determining that the received packet is a PRP packet, forward the received packet to a predetermined next-hop network device toward the destination tunnel endpoint.

One aspect of the instant disclosure provides a non-transitory computer-readable storage medium storing instructions to: determine at a network device operating as a source tunnel endpoint, whether a received packet is a Parallel Redundancy Protocol (PRP) packet; in response to determining that the received packet is not a PRP packet, apply Equal-Cost Multi-Path (ECMP)-based load balancing and forward the received packet to an ECMP next-hop network device toward a destination tunnel endpoint; and, in response to determining that the received packet is a PRP packet, forward the received packet to a predetermined next-hop network device toward the destination tunnel endpoint.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A method for implementing Parallel Redundancy Protocol (PRP) in an overlay network, the method comprising:
determining, at a network device operating as a source tunnel endpoint, whether a received packet is a Parallel Redundancy Protocol (PRP) packet;
in response to determining that the received packet is not a PRP packet, applying Equal-Cost Multi-Path (ECMP)-based load balancing and forwarding the received packet to an ECMP next-hop network device toward a destination tunnel endpoint; and
in response to determining that the received packet is a PRP packet, forwarding the received packet to a predetermined next-hop network device toward the destination tunnel endpoint.

2. The method of claim 1, wherein a predetermined physical port on the network device is coupled to a PRP sender, and wherein determining whether the received packet is a PRP packet comprises identifying an incoming physical port of the received packet.

3. The method of claim 2, wherein the PRP sender is coupled to a second network device operating as a second source tunnel endpoint, and wherein the second network device is to receive a duplicate PRP packet and forward the duplicate PRP packet to a predetermined second next-hop network device toward a second destination tunnel endpoint, the second next-hop network device being different from the predetermined next-hop network device.

4. The method of claim 3, wherein the PRP packet and the duplicate PRP packet are routed on independent, non-overlapping paths to a PRP receiver coupled to the first and second destination tunnel endpoints.

5. The method of claim 1, further comprising:
encapsulating the received packet;
in response to determining that the received packet is a PRP packet, inserting a PRP-specific indicator into a header field of the encapsulated packet.

6. The method of claim 5, wherein the PRP-specific indicator comprises a virtual local area network (VLAN) tag.

7. The method of claim 5, further comprising:
in response to detecting the PRP-specific indicator at an intermediate network device between the source and destination tunnel endpoints, forwarding the encapsulated packet to a designated next-hop network device toward the destination tunnel endpoint, thereby allowing the encapsulated packet to be routed on a PRP-specific path; and
in response to detecting an absence of the PRP-specific indicator, forwarding the encapsulated packet on an ECMP path toward the destination tunnel endpoint.

8. The method of claim 7, wherein forwarding the encapsulated packet to the designated next-hop network device comprises applying an IP-routing underlay protocol, and wherein the IP-routing underlay protocol comprises open shortest path first (OSPF) or external Border Gateway Protocol (eBGP)..

9. The method of claim 1, wherein forwarding the received packet to a predetermined next-hop network device comprises:
overriding ECMP forwarding; and
applying a Policy Based Routing (PRB) policy.

10. A network device operating as a source tunnel endpoint, comprising:
a processing resource; and
a non-transitory machine-readable storage medium comprising instructions executable by the processing resource to:
determine whether a received packet is a Parallel Redundancy Protocol (PRP) packet;
in response to determining that the received packet is not a PRP packet, apply Equal-Cost Multi-Path (ECMP)-based load balancing and forward the received packet to an ECMP next-hop network device toward a destination tunnel endpoint; and
in response to determining that the received packet is a PRP packet, forward the received packet to a predetermined next-hop network device toward the destination tunnel endpoint.

11. The network device of claim 10, comprising a predetermined physical port coupled to a PRP sender;
wherein determining whether the received packet is a PRP packet comprises identifying an incoming physical port of the received packet.

12. The network device of claim 11, wherein the PRP sender is coupled to a second network device operating as a second source tunnel endpoint, and wherein the second network device is to receive a duplicate PRP packet and forward the duplicate PRP packet to a predetermined second next-hop network device toward a second destination tunnel endpoint, the second next-hop network device being different from the predetermined next-hop network device.

13. The network device of claim 10, wherein the instructions are further to:
encapsulate the received packet;
in response to determining that the received packet is a PRP packet, insert a PRP-specific indicator into a header field of the encapsulated packet.

14. The network device of claim 13, wherein the PRP-specific indicator comprises a virtual local area network (VLAN) tag.

15. The network device of claim 13, wherein the PRP-specific indicator causes an intermediate network device between the source and destination tunnel endpoints to:
in response to detecting the PRP-specific indicator, forward the encapsulated packet to a designated next-hop network device toward the destination tunnel endpoint, thereby allowing the encapsulated packet to be routed on a PRP-specific path; and
in response to detecting an absence of the PRP-specific indicator, forward the encapsulated packet on an ECMP path toward the destination tunnel endpoint.

16. The network device of claim 15, wherein forwarding the encapsulated packet to the designated next-hop network device comprises applying an IP-routing underlay protocol, and wherein the IP-routing underlay protocol comprises open shortest path first (OSPF) or external Border Gateway Protocol (eBGP).

17. The network device of claim 10, wherein, to forward the received packet to the predetermined next-hop network device, the instructions are executable by the processing resource to:
override ECMP forwarding; and
apply a Policy Based Routing (PRB) policy.

18. A non-transitory computer-readable storage medium storing instructions to:
determine, at a network device operating as a source tunnel endpoint, whether a received packet is a Parallel Redundancy Protocol (PRP) packet;
in response to determining that the received packet is not a PRP packet, apply Equal-Cost Multi-Path (ECMP)-based load balancing and forward the received packet to an ECMP next-hop network device toward a destination tunnel endpoint; and
in response to determining that the received packet is a PRP packet, forward the received packet to a predetermined next-hop network device toward the destination tunnel endpoint.

19. The non-transitory computer-readable storage medium of claim 18, wherein a predetermined physical port on the network device is coupled to a PRP sender, and wherein determining whether the received packet is a PRP packet comprises identifying an incoming physical port of the received packet.

20. The non-transitory computer-readable storage medium of claim 18, wherein the instructions are further to:
in response to determining that the received packet is a PRP packet, insert a PRP-specific indicator into a header field of the received packet, wherein the PRP-specific indicator comprises a virtual local area network identifier (VLAN ID).
